(19) United States
(12) Patent Application Publication
(10) Pub. No.: US 2009/0243131 A1
(43) Pub. Date: Oct. 1, 2009

(54) Injection Molding Machine and Control Method of the Injection Molding Machine

(75) Inventors: Motoki Tanaka, Chiba (JP); Okito Nishio, Chiba (JP); Masahiro Hayakawa, Chiba (JP); Naohiro Yoshida, Chiba (JP); Daisuke Maruo, Chiba (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Sumitomo Heavy Industries, Ltd., Shinagawa-ku, Tokyo (JP)

(21) Appl. No.: 12/085,952

(22) PCT Filed: Sep. 14, 2007
(86) PCT No.: PCT/JP2007/067935

§ 371 Date: Jun. 3, 2008

(30) Foreign Application Priority Data
Sep. 19, 2006 (JP) 2006-252523

(51) Int. Cl. B29C 45/76; B29C 47/96

(52) U.S. Cl. 264/40.5; 425/149

(57) ABSTRACT

An injection molding machine includes a pressure detector 35, 48, 87 or 151 being a strain detector configured to detect strain when voltage is input to the strain detector. A value of the voltage being input to the pressure detector 35, 48, 87 or 151 is changed during one molding cycle.

### TECHNICAL FIELD

The present invention generally relates to injection molding machines and a control method of the injection molding machines. More specifically, the present invention relates to an injection molding machine having a pressure detector such as a load cell and a method for inputting voltage to the pressure detector such as the load cell provided in the injection molding machine.

### BACKGROUND ART

In an injection molding machine having an injection apparatus, a molding apparatus, and a mold clamping apparatus, resin is heated and melted in a heating cylinder of the injection apparatus. The molten resin is injected into a cavity of a mold apparatus under high pressure so that the cavity is filled with the molten resin. The molten resin is then cooled and solidified so as to obtain a molded article.

The mold apparatus includes a stationary mold and a movable mold. The movable mold is advanced to and retracted from the stationary mold along tie bars by the mold clamping apparatus, so as to perform mold closing, mold clamping and mold opening.

When the injection apparatus is advanced after mold clamping by the mold clamping apparatus is completed, a nozzle of the heating cylinder is passed through a nozzle passing hole formed in a stationary platen so as to be pushed to a spur bushing provided at a rear surface of the stationary mold.

Next, resin melted by the injection apparatus is pressed by the screw in the heating cylinder and injected from the nozzle. The injected and molten resin passes through the spur bushing and a spur so as to fill a cavity formed between the stationary mold and the movable mold.

A pressure detector is provided in a screw driving mechanism of the injection apparatus. The pressure detector is configured to detect the pressure of the molten resin applied to the screw, that is a reaction force of the molten resin.

In addition, a mold clamping sensor is provided at a tie bar of the mold clamping apparatus as a pressure detector configured to measure the mold clamping force of the movable mold and the stationary mold.

Furthermore, an ejector apparatus is provided at a movable platen of the mold clamping apparatus so that the molded article can be released from the molds after mold opening. A pressure detector is provided at the movable platen so as to measure an ejection force generated by the ejector driving part.

It is general practice to use a load cell as the above-mentioned pressure detector or the mold clamping sensor. By the load cell, a voltage of a bridge circuit of a strain gage is converted to a pressure. More specifically, applied loads (pressure) are measured from electric potential differences (change of output voltage) of the bridge circuit due to resistance change of the strain gage forming the bridge circuit attached to a load cell main body.

Meanwhile, a back pressure detecting device for an injection molding machine having the following structure is suggested. In this back pressure detecting device for an injection molding machine, back pressure control in a metering process is performed based on the information from a first sensor, and a spring member acting against a retreating force of a screw is arranged and a stopper for preventing the spring member from being plastically deformed is employed when the maximum retreating force of the screw in the metering process is generated and control in the injection and dwelling process is performed based on the information from the second sensor. (See, for example, Patent Document 1).

### [Patent Document 1] Japanese Patent No. 3313666

### DISCLOSURE OF THE INVENTION

### Problems to be Solved by the Invention

However, the collation applied to the strain gage of the load cell is not so high. Accordingly, the load cell may be influenced by a disturbance, for example, noise from a peripheral device such as a motor. Hence, unevenness or change is generated in output of the load cell so that resolution of loads, namely SN ratio (signal to noise ratio) becomes low and thereby precise output may not be achieved.

For example, although high precision is required for detecting the pressure of the molten resin applied to the screw during a holding pressure process, a metering process and others, it may be difficult to precisely know the output of the load cell if the load cell is influenced by a disturbance such as noise.

On the other hand, while it is not always necessary to measure the applied loads (pressure) with high precision in the injection molding machine, a constant voltage is always applied to the strain gage in the conventional injection molding machine. Accordingly, if a high voltage is always applied to the strain gage in order to minimize disturbances such as noise, the strain gage is overheated and detection error may be generated.

### Means for Solving Problems

Accordingly, embodiments of the present invention may provide a novel and useful injection molding machine and control method of the injection molding machine solving one or more of the problems discussed above.

More specifically, the embodiments of the present invention may provide an injection molding machine and a control method of the injection molding machine, whereby an applied load (pressure) can be detected with high precision if necessary.

One aspect of the present invention may be to provide an injection molding machine, including a pressure detector being a strain detector configured to detect strain when voltage is input to the pressure detector; wherein a value of the voltage being input to the pressure detector is changed during one molding cycle.

The pressure detector may include a variable amplification device, and a ratio of the voltage being input to the pressure detector and a voltage being output from the pressure detector is calculated by the variable amplification device.

The pressure detector may be configured to detect a mold clamping force of a mold clamping apparatus, and the voltage being input to the pressure detector may have a highest value in a case where the mold clamping apparatus is in a mold opening limit state or before the mold clamping apparatus performs a mold clamping operation.

The pressure detector may be configured to detect a mold clamping force of a mold clamping apparatus, and the voltage being input to the pressure detector may have a lowest value during at least a mold opening operation or a mold closing operation.

The pressure detector may be configured to detect an injection pressure of an injection apparatus, and the voltage being input to the pressure detector may have a highest value during a metering process.

The pressure detector may be configured to detect an injection pressure of an injection apparatus, and the voltage being input to the pressure detector may have a lowest value after a metering process is completed before an injection process is started.

The pressure detector may be configured to detect an ejection force of an ejection apparatus, and the voltage being input to the pressure detector may have a highest value during an ejection operation.

The pressure detector may be configured to detect an ejection force of an ejection apparatus, and the voltage being input to the pressure detector may have a lowest value after an ejection operation is completed before the ejection operation of a next molding cycle is started.

Another aspect of the present invention may be to provide a control method of an injection molding machine, the injection molding machine having a pressure detector being a strain detector configured to detect strain when voltage is input to the pressure detector, the control method including the steps of changing a value of the voltage being input to the pressure detector during one molding cycle.

The pressure detector may be configured to detect a mold clamping force of a mold clamping apparatus, and the voltage being input to the pressure detector may be changed so as to have a highest value in a case where the mold clamping apparatus is in a mold opening limit state or before the mold clamping apparatus performs a mold clamping operation.

The pressure detector may be configured to detect a mold clamping force of a mold clamping apparatus, and the voltage being input to the pressure detector may be changed so as to have a lowest value during a mold opening operation or a mold closing operation.

The pressure detector may be configured to detect an injection pressure of an injection apparatus, and the voltage being input to the pressure detector may be changed so as to have a highest value during a metering process.

The pressure detector may be configured to detect an injection pressure of an injection apparatus, and the voltage being input to the pressure detector may be changed so as to have a lowest value after a metering process is completed before an injection process is started.

The pressure detector may be configured to detect an ejection force of an ejection apparatus, and the voltage being input to the pressure detector may be changed so as to have a highest value during an ejection operation.

The pressure detector may be configured to detect an ejection force of an ejection apparatus, and the voltage being input to the pressure detector may be changed so as to have a lowest value after an ejection operation is completed before the ejection operation of a next molding cycle is started.

### EFFECT OF THE INVENTION

According to the embodiment of the present invention, it is possible to provide an injection molding machine having a pressure detector configured to detect an applied load (pressure) with high precision if necessary, and a control method of the injection molding machine. Other objects, features, and advantages of the present invention will become more apparent from the following detailed description when read in conjunction with the accompanying drawings.

### BRIEF DESCRIPTION OF DRAWINGS

FIG. 1 is a schematic view of a screw-type motor driven injection molding machine as an example of an injection molding machine where the present invention is applied;

FIG. 2 is a block diagram showing a circuit structure of a pressure detector of an embodiment of the present invention;

FIG. 3 shows graphs of the relationships between a molding process (time) indicated by a set value of a mold clamping force necessary for advancing and retracting a movable platen configured to detect the mold clamping force in a mold clamping apparatus and an input voltage to a bridge circuit and an applied load (voltage);

FIG. 4 shows graphs of the relationship between the molding process time (time) and an input voltage to a bridge circuit and an applied load (voltage), in a load cell for detecting a resin pressure in an injection apparatus;

FIG. 5 shows graphs of the relationship between the molding process time (time) and an input voltage to a bridge circuit and an applied load (voltage), in a load cell for detecting an ejection force in an ejector apparatus; and

FIG. 6 is a schematic view showing another structure of the mold clamping apparatus of the injection molding machine where the present invention is applied.

### EXPLANATION OF REFERENCE SIGNS

1 injection molding machine
20 injection apparatus
35 load cell for detecting resin pressure
48 mold clamping force sensor
50 mold clamping apparatus
55 tie bar
84 ejector plate
87 load cell for detecting an ejection force
151 load cell for detecting a mold clamping force

### BEST MODE FOR CARRYING OUT THE INVENTION

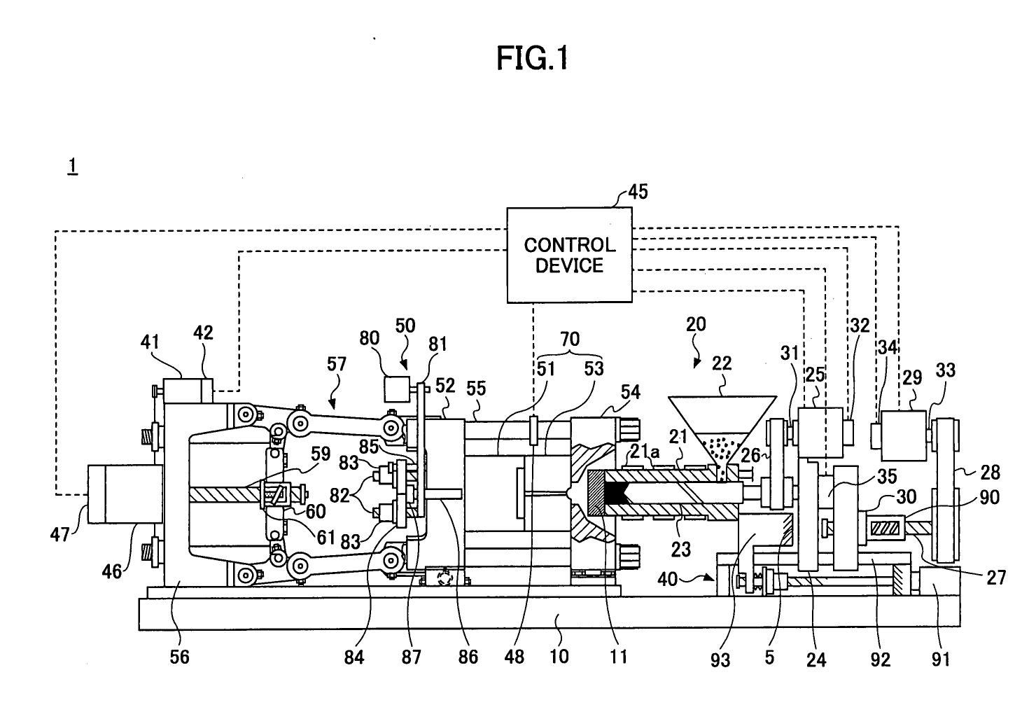

A description is given below, with reference to the FIG. 1 through FIG. 6 of embodiments of the present invention.

A structure of an injection molding machine where the present invention is applied is discussed with reference to FIG. 1.

Here, FIG. 1 is a schematic view of a screw-type motor driven injection molding machine as an example of an injection molding machine where the present invention is applied.

An injection molding machine 1 shown in FIG. 1 includes a frame 10 and an injection apparatus 20, a mold clamping apparatus 50, and others provided on the frame 10.

The injection apparatus 20 includes a heating cylinder 21. A hopper 22 is provided on the heating cylinder 21. A heater 21a is provided on the external circumference of the heating cylinder 21. The heater 21a is configured to heat the heating cylinder 21. A screw 23 is rotatably and movably provided in the heating cylinder 21. A rear end of the screw 23 is rotatably supported by a movable supporting part 24.

A metering motor 25 such as a servo motor is provided at the movable supporting part 24 as a driving part. Rotation of the metering motor 25 is transferred to the screw 23 which is a driven part via a timing belt 26 provided to an output shaft 31.

A rotation detector 32 is connected to a rear end of the output shaft 31. The rotation detector 32 detects the number or amount of rotation of the metering motor 32 so as to detect the rotational speed of the screw 23.

The injection apparatus 20 includes a ball screw shaft 27 provided in parallel with the screw 23. The ball screw shaft 27 is fitted to a ball screw nut 90 so that a motion direction converting mechanism configured to convert rotational motion to linear motion is formed.

When an injection motor 29 as a driving part is driven so that the ball screw shaft 27 is rotated via a timing belt 28, a support 30 and the movable supporting part 24 fixed to the ball screw nut 90 are advanced or retracted. As a result of this, the screw 23 as a driven part can be advanced or retracted.

A position detector 34 connected to a rear end of the output shaft 33 of the injection motor 29 detects the number or amount of rotation of the injection motor 29 so as to detect the position of the screw 23 representing a driving state of the screw 23.

In addition, a load cell 35 for detecting a resin pressure is provided between the movable supporting part 24 and the support 30. The load cell 35 is configured to detect a pressure (reaction force) of the molten resin applied to the screw 23.

The injection apparatus 20 includes a plasticization moving apparatus 40 as a driving mechanism configured to drive the injection apparatus 20 so as to apply a nozzle touch pressure. The plasticization moving apparatus 40 includes a plasticization moving driving part 91 and an injection apparatus guide part 92. The injection apparatus guide part 92 is engaged with a front flange 93, the support 30, and the movable support part 24 forming the injection apparatus 20.

Accordingly, when the plasticization moving driving part 91 is driven, the injection apparatus 20 including the heating cylinder 21 can horizontally move on the frame 10 along the injection apparatus guide part 92. By driving the plasticization moving apparatus 40 discussed above, the injection apparatus 20 is advanced at a designated timing and the nozzle of the heating cylinder 21 comes in contact with (touches) the stationary mold 53 so that nozzle touch is performed.

The heating cylinder 21 is supported by the front flange 93. A contact part 5 is provided at a rear end of the front flange 93. The contact part 5 works as a restriction part configured to restrict advancing and retracting of the screw 23.

The contact part 5 is a stopper configured to restrict advancing motion at an apparatus side when the screw 23 is advanced most, so that a head end part of the screw 23 comes in contact with a nozzle part (not shown) provided at a front part of the heating cylinder 21 and is not damaged. Because of this, when the screw 23 is at a stroke advancing limitation position, the contact part 5 comes in contact with the movable support part 24.

At this time, a reaction force of all axial forces provided by the injection motor 29 is detected by the load cell 35 for detecting resin pressure. In this case, properties of a mechanism part single body of the injection apparatus can be determined by the contact part 5 and the movable support part 24 contacting to each other. In addition, it is not always necessary to provide the contact part 5 at the rear end of the front flange 93. The rear end of the heating cylinder 21 may be the contact part 5.

Furthermore, as another example of the restriction part, a head end of the heating cylinder 21 may be blocked so that advancing the screw 23 is restricted and the reaction force is detected in a state where a load plate 11 working as a restricting part is provided. Advancing the screw 21 is restricted in a state where resin fills the heating cylinder 21.

Accordingly, the resin pressure of the resin provided in the heating cylinder 21, applied by the injection motor 29, which is the reaction force of the all axial forces, is detected by the load cell 35 for detecting the resin pressure which is the above-mentioned pressure detector.

In this case, not only properties of the mechanism part single body of the injection apparatus 20 but also properties of the entire injection apparatus 20 including influence of a plasticizing part such as the screw 23 or the heating cylinder 21 including damage to the screw 23 are detected. In addition, properties of the plasticizing single body can be calculated by using the properties of the mechanism part single body detected by the contact part and the properties of the entire injection apparatus 20 detected by the load plate 11.

The metering motor 25, the rotation detector 32, the injection motor 29, the position detector 34, and the load cell 35 for detecting the resin pressure are connected to a control device 45. Detection signals being output from the rotation detector 32, the position detector 34, and the load cell 35 are sent to the control device 45. The control device 45 controls operations of the metering motor 25 and the injection motor 29 based on the detecting signals.

The control device 45 may be solely provided or provided as a part of a control part configured to control the entire injection molding machine.

The mold clamping apparatus 50 includes a stationary platen 54 and a toggle support 56. The stationary platen 54 works as a stationary mold supporting device fixed to the frame 10. The toggle support 56 as a base plate is provided to be movable relative to the frame 10. There is a distance between the stationary platen 54 and the toggle support 56. The toggle support 56 works as a toggle type mold clamping support apparatus.

Plural tie bars 55, for example four tie bars, are provided as a guide part between the stationary platen 54 and the toggle support 56.

A movable platen 52 faces the stationary platen 54. The movable platen 52 works as a movable mold support apparatus which can be advanced and retracted (moved in left and right directions in FIG. 1) along the tie bars 55. The movable platen 52 is moved along the tie bars 55 by operations of a toggle mechanism 57 so that mold closing, mold clamping and mold opening are performed.

A mold apparatus 70 includes a stationary mold 53 and the movable mold 51.

The stationary mold 53 is attached to a mold attaching surface of the stationary platen 54 facing the movable mold 51. On the other hand, the movable mold 51 is attached to a mold attaching surface of the movable platen 52 facing the stationary platen 54.

An ejector apparatus is provided at a rear end (left end in FIG. 1) of the movable platen 52. An ejector motor 80 of the ejector apparatus is provided at a rear upper part of the movable platen 52. A belt 81 is wound with respect to an output shaft of the motor 80. By driving the ejector motor 80, rotational driving of the motor 80 is transferred to the belt 81.

As a result of this, ball screw shafts 82 are rotated via the belt 81 so that nuts 83 are advanced or retracted and an ejector plate 84 where the nuts 83 are fixed is advanced or retracted along a guide pin 85. When the ejector plate 84 is advanced, an ejector rod 86 pushes an ejection plate not shown in FIG. 1 in the movable mold 51 so that the molded article is released.

A load cell 87 for detecting an ejection force is provided at a rear end part of the ejector rod 86. The load cell 87 works as a pressure detecting device configured to detect an ejection force by the ejector rod 86.

The toggle mechanism 57 as a toggle type mold clamping apparatus is provided between the movable platen 52 and the toggle support 56. A mold clamping motor 46 is provided at the rear end of the toggle support 56. The mold clamping motor 46 works as a mold clamping driving source configured to operate the toggle mechanism 57.

The mold clamping motor 46 includes a motion direction converting apparatus not shown. The motion direction converting apparatus is formed by a ball screw mechanism or the like. The ball screw mechanism is configured to convert rotational motion to reciprocating motion.

The mold clamping motor 46 advances and retracts (moves in left and right directions in FIG. 1) a ball screw shaft 59 so as to operate the toggle mechanism 57.

It is preferable that the mold clamping motor 46 be a servo motor. The mold clamping motor 46 includes a mold opening and closing position sensor 47 as an encoder configured to detect the number of rotations.

The mold clamping motor 46 as a driving part is driven and a cross head 60 is advanced or retracted so that the toggle mechanism 57 can be operated. In this case, by advancing (moving in a right direction in FIG. 1) the cross head 60, the movable platen 52 is advanced so that mold closing is performed. In addition, a mold clamping force which is calculated by multiplying a propulsive force by the mold clamping motor 46 by a toggle magnification is generated, and mold clamping is performed by the mold clamping force.

A mold thickness motor 41 as a mold clamping position adjusting driving source is provided at an upper part of the read end of the toggle support 56.

It is preferable that the mold thickness motor 41 be a servo motor. The mold thickness motor 41 includes a mold clamping position sensor 42 as an encoder configured to detect the number of rotations.

Furthermore, in this embodiment, a mold clamping sensor 48 as a pressure detector is provided on one of the tie bars 55. The mold clamping force sensor 48 is a sensor configured to detect strain (mainly, extension) of the tie bar 55. A tensile force is applied to the tie bar 55 corresponding to the mold clamping force at the time of mold clamping. The tie bar 55 slightly extends in proportion to the mold clamping force.

Accordingly, it is possible to determine the mold clamping force actually applied to the mold apparatus 70 by detecting an extended amount of the tie bar 55 with the mold clamping sensor 48. When the stationary mold 53 and the movable mold 51 come in contact with each other, a reaction force of the entire axial force provided by the mold clamping motor 46 as the driving part is detected by the mold clamping force sensor 48 as the pressure detector. In other words, since the advancing motion of the movable platen 52 is restricted by the stationary mold 53, the stationary mold 53 works as a restriction part.

The load cell 87 for detecting the ejection force, the mold clamping force sensor 48, the mold closing and opening position sensor 42, the mold clamping motor 46, and the mold thickness motor 41 are connected to the control device 45. The detecting signals being output from the load cell 87 for detecting the ejection force, the mold clamping force sensor 48, and the mold closing and opening position sensor 42 are transferred to the control device 45. The control device 45 is configured to control the ejector motor 80, the mold clamping motor 46, and the mold thickness motor 31 based on the detecting signals.

Next, operations at the time of molding of the injection molding machine having the above discussed structure are discussed.

When the mold clamping motor 46 is driven in a forward direction, the ball screw shaft 59 is rotated in the forward direction so as to be advanced (moved in the right direction in FIG. 1). Following this, the cross head 60 is advanced so that the toggle mechanism 57 is operated and the movable platen 52 is advanced.

When the movable mold 51 attached to the movable platen 52 and the stationary mold 53 come in contact with each other, mold clamping is performed. In the mold clamping process, by driving the mold clamping motor 46 further in the forward direction, a mold clamping force is generated in the mold clamping apparatus by the toggle mechanism 57.

When the screw 23 is rotated in the heating cylinder 21, resin pellets which are a molding material supplied from the hopper 22 are melted by the heater 21a provided on the heating cylinder 21. The molten resin is stored at the head end of the screw 23 so as to be injected from the nozzle situated at the head end of the heating cylinder 21. The molten resin fills a cavity space formed in the mold apparatus 70.

When the mold opening is performed, the mold clamping motor 46 is driven in the backward direction so that the ball screw shaft 59 is rotated in the backward direction. Following this, the cross head 60 is retracted so that the toggle mechanism 57 is operated and the movable platen 52 is retracted.

When the mold opening is completed, the ejector motor 80 is driven and the ejector apparatus provided in the movable platen 52 is operated. As a result of this, the mold article in the movable mold 51 is ejected from the movable mold 51.

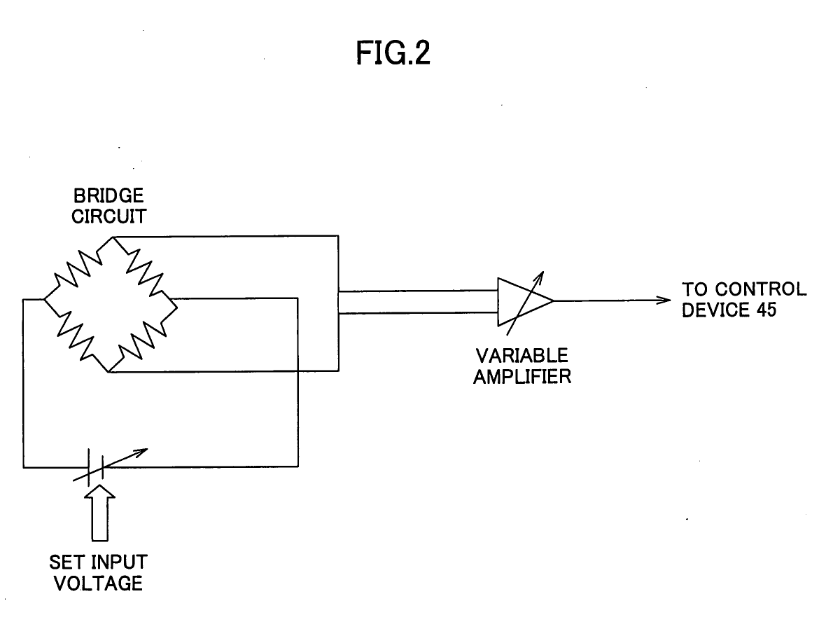

Next, a circuit structure of a pressure detector, namely the load cell 35 for detecting the resin pressure, the load cell 87 for detecting the ejection force, and the mold clamping sensor 48 of the embodiment of the present invention is discussed with reference to FIG. 2. Here, FIG. 2 is a block diagram showing a circuit structure of a pressure detector of an embodiment of the present invention.

Referring to FIG. 2, the pressure detector of the embodiment of the present invention is a strain detector configured to detect strain by inputting a voltage. A strain gage is used as the pressure detector. The strain gage is a detecting circuit configured to detect change of a resistance value by using a bridge circuit.

The strain gage forms the bridge circuit by combining plural resistance wires. The strain gage is configured to amplify the difference between output voltage and input voltage from a designated position of the bridge circuit by an amplifier so as to output this difference as a voltage signal to the control device 45 (see FIG. 1).

It is normal practice that the circuit is formed so that a standard voltage of the input voltage is zero (0) volts, namely ground potential. When there is no change in each resistance wire, namely the resistance value, the bridge circuit outputs zero (0) volts. When one or two of the resistance wires are changed, that is when the resistance wire is expanded or contracted so that the resistance value is changed, the balance of the resistance values in the bridge circuit is changed so that the voltage in proportion to the change of the resistance value is output.

The voltage being input to the bridge circuit based on instruction from the control device (see FIG. 1) is variable. Necessary voltage is input to the bridge circuit at a designated timing.

The amplifier of this embodiment is a variable amplifier. The ratio of the output voltage from the bridge circuit and an input voltage to the bridge circuit, namely “output voltage/input voltage” is calculated. Accordingly, even if the voltage is low, measurement can be made. In addition, even if the input voltage is changed, it is possible to detect the resistance change of the bridge circuit based on the result of the calculation.

Here, as shown in FIG. 2, the variable amplifier may have a single amplifying function whereby the input voltage is variably amplified in an analog manner so as to be output. In addition, plural amplifying functions are connected between the bridge circuit and the control device via a switch so that the switch may be switched corresponding to the input voltage.

For example, when the input voltage is 1 V and the output voltage from the bridge circuit is 1 mV in a state where loads of 10,000 N are applied, the output is increased by 1000 so that the output to the control device 45 is amplified to 1 V. By such a load detecting circuit, when the input voltage is 10 V, the output voltage from the bridge circuit is 10 mV in a state where loads of 10,000 N are applied. Because of this, the output is increased by 100 with consideration of the increase of the input voltage in the variable amplifier so that the output to the control device 45 is amplified to 1 V. Hence, it is possible to evaluate the detected value of the load detector in this example as well as when the load detector is used in a normal situation.

In addition, when noise of 1 mV is applied to the load detection circuit, under normal conditions of the input voltage (1 V), the output of the bridge circuit is detected as 2 mV which is 1 mV plus noise of 1 mV and therefore the output value of the control device 45 is 2 V. On the other hand, under conditions of the input voltage of 10 V at the high voltage time, even if noise of 1 mV is added, the output of the bridge circuit is detected as 11 mV which is 10 mV plus noise of 1 mV. Accordingly, it is possible to improve the detection precision. Hence, it is possible to decrease the SN ratio (ratio of the detected value to the noise) of approximately 50% to approximately 10%.

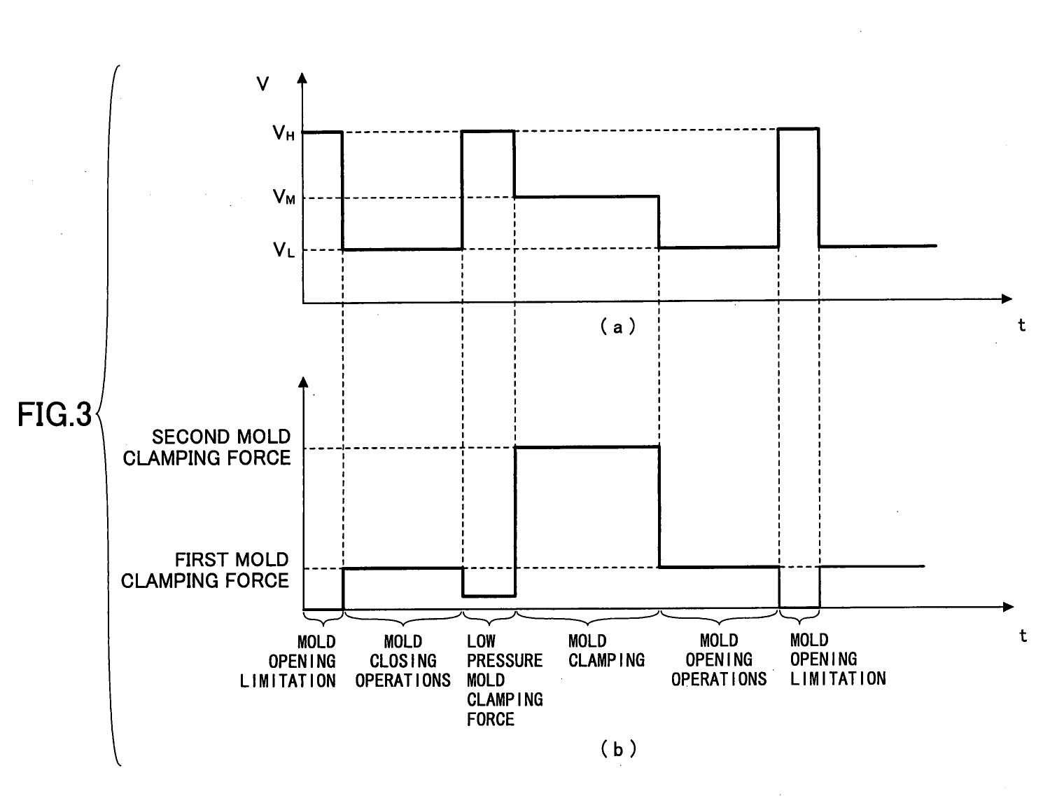

Next, it is discussed with reference to FIG. 3 through FIG. 5 how the input voltage to the pressure detector having the bridge circuit and the variable amplifier should be determined in order to detect, with high precision, the loads (pressure) applied when they are required, namely in order to make the output of the pressure detector have high precision even if the load is small compared to the capacity of the pressure detector.

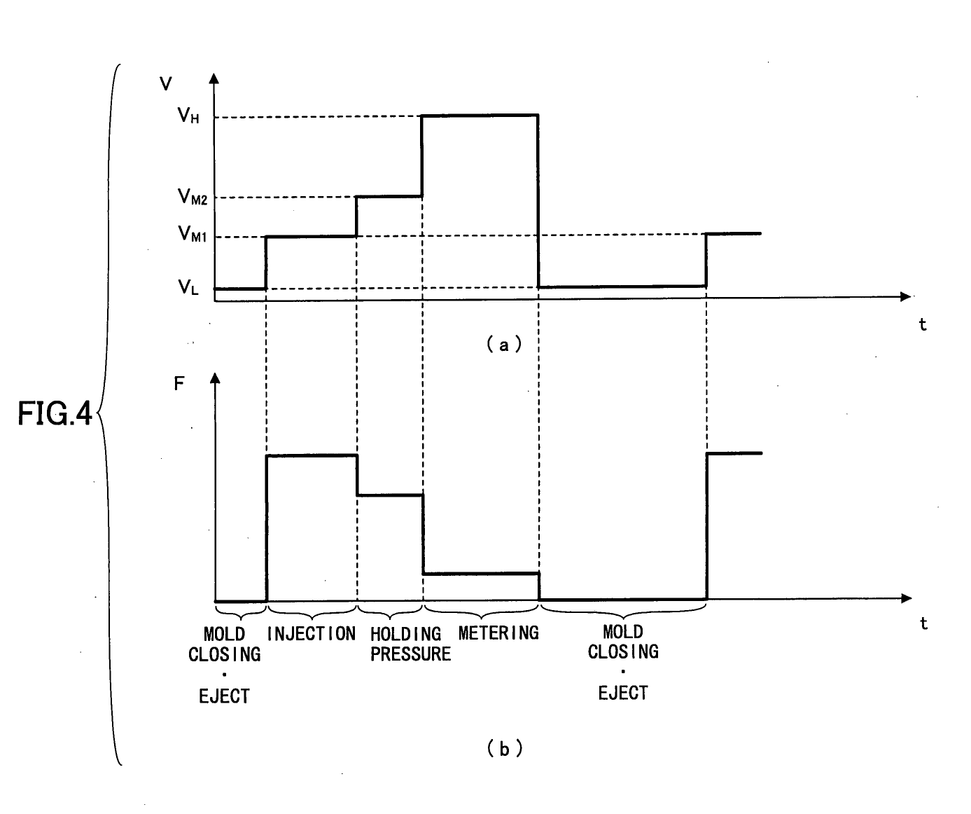

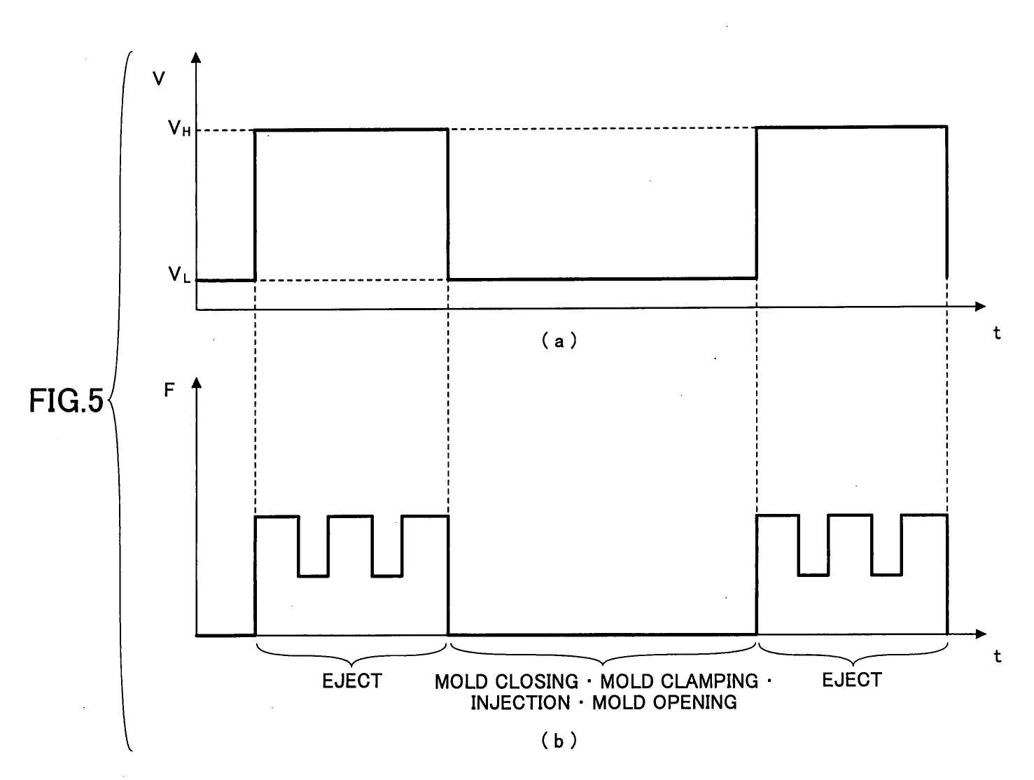

Here, FIG. 3 shows graphs of the relationships between a molding process (time) indicated by a set value of a mold clamping force necessary for advancing and retracting the movable platen 52 configured to detect the mold clamping force in the mold clamping apparatus 50 and an input voltage to a bridge circuit and an applied load (voltage). FIG. 4 shows graphs of the relationship between the molding process time (time) and an input voltage to a bridge circuit and an applied load (voltage), in the load cell 35 for detecting a resin pressure in the injection apparatus 20. FIG. 5 shows graphs of the relationship between the molding process time (time) and an input voltage to a bridge circuit and an applied load (voltage), in a load cell 87 for detecting an ejection force in an ejector apparatus.

In this embodiment, as discussed above, the input voltages to the bridge circuits of the mold clamping force sensor 48, the load cell 35 for detecting the resin pressure, and the load cell 87 for detecting the ejector force are variable.

In a case where the applied loads (pressure) are detected with high precision, the input voltage is high. If the input voltage is high, it is possible to drastically reduce influence of disturbance such as a peripheral device including a motor so that precise output can be achieved by increasing the SN ratio.

On the other hand, if high precision is not required for detection, the input voltage is low. Accordingly, it is possible to avoid always applying a high voltage thus preventing a situation where the strain gage is overheated, which would generate detection errors.

Thus, the value of the input voltage is changed based on the level of the required detection precision in the embodiment of the present invention.

First, FIG. 1 and FIG. 3 are referred to.

FIG. 3(a) shows the relationships between the molding process (time t) and a set input voltage (V) to the bridge circuit of the mold clamping sensor 48 configured to detect the mold clamping force of the mold clamping apparatus 50. FIG. 3(b) shows the relationship between the molding process (time t) and the mold clamping force (F) to be set.

In the mold clamping apparatus 50, when the movable platen is retracted from where the parting surface of the movable mold 51 comes in contact with the parting surface of the stationary mold 53 so that mold opening operations for releasing the movable mold 51 from the stationary mold 53 have been performed, if the movable platen 52 is situated in a mold opening limitation state where the movable platen 52 is positioned rear-most in the movable range (left-most side in FIG. 1), the mold clamping force is not set.

When the movable platen 52 is situated in the mold opening limitation state, namely with no load, an original point adjustment of the mold clamping force sensor 48 is performed and therefore a high voltage V_{H} is input to the bridge circuit of the mold clamping sensor 48.

When the bridge circuit is used for a long period of time, resistance values of the resistance wires of the bridge circuit gradually and slightly change with time. When there is change of the resistance value with time, the output voltage from the bridge circuit which is initially set as zero (0) volts is no longer equal to zero (0) volts, instead, a voltage such as 10 mV which is in proportion to the change of the resistance values with time is output. This change of the output voltage is called “drift”.

In other words, while the output voltage is zero (0) volts at the time of no load time where strain is not generated in the tie bars 55, the output voltage drifts after a certain time passes even if no loads are applied so as to be, for example, 10 mV. Accordingly, a voltage where 10 mV is always added to a voltage generated from the actual strain (expansion) of the tie bars 55 is output.

The strain (expansion) of the tie bars 55 has a value obtained by converting the output voltage. When the drift of the output voltage happens, the strain (expansion) of the tie bars 55 has a value different from the actual strain (expansion) by the voltage drift. Hence, a detection error of the strain may be generated.

Accordingly, the voltage is corrected by adding or deleting the voltage value of the drift of the output voltage at the time of no load to or from the actual output voltage value so that the voltage value of the drift is cancelled (original point adjustment).

There are soft-reset and hard-reset methods in such corrections (original point adjustment). In the soft-reset correction method an analog to digital converting circuit is configured to perform analog-to-digital conversion of the output voltage being output from the bridge circuit via the amplifier (AMP) and a digital value corresponding to the voltage drift is added to or deleted from the digital value of the output voltage obtained by the A-D conversion so that the voltage drift is cancelled. In the soft-reset method data indicating the output voltage are processed and corrected by software. On the other hand, in the hard-reset correction method a circuit is configured to change the standard voltage supplied to a comparing amplifier for generating the output voltage by the voltage corresponding to the drift voltage and the voltage drift is cancelled.

In order to perform such correction (original point adjustment), it is necessary to detect the output with high precision. A high voltage V_{H} is input to the bridge circuit of the mold clamping sensor 48.

Then, the mold clamping apparatus 50 performs mold closing operations. The “mold closing” means that the movable mold 51 approaches the stationary mold 53 from a state where the movable mold 51 is not in contact with the stationary mold 53 to a state where the parting surface of the movable mold 51 comes in contact with the parting surface of the stationary mold 53.

In this mold closing state, a first mold clamping force is set as a mold clamping force. On the other hand, the voltage being input to the bridge circuit of the mold clamping sensor 48 is changed from the high voltage V_{H} to the low voltage V_{L}. During this mold closing state, high precision is not required for detecting the mold clamping force. Hence, it is possible to prevent overhearing the strain gage and generating detection errors due to high temperature.

Near the completion of the mold closing operations, a mold clamping force that is lower than the above-mentioned first mold clamping force is set. At this time, if a force applied to the mold clamping apparatus 50 is greater than necessary force, the movable mold 51 and the stationary mold 53 suddenly collide with each other so that the movable mold 51 and the stationary mold 53 may be damaged. In order to prevent this situation so that the movable mold 51 and the stationary mold 53 are protected, it is necessary to detect the generated mold clamping force. The voltage being input to the bridge circuit of the mold clamping sensor 48 is changed from the low voltage VL to the high voltage VH. The ratio corresponding to the input voltage is calculated by the variable amplifier.

Then, the mold clamping apparatus 50 performs mold clamping operations. The “mold clamping” means that a force is further applied to the movable mold 51 in a state where the parting surface of the movable mold 51 is in contact with the parting surface of the stationary mold 53 so that the stationary mold 53 is pushed by the movable mold 51.

At this stage of mold clamping, a second mold clamping force that is greater than the above-mentioned first mold clamping force is set as the mold clamping force. On the other hand, the voltage being input to the bridge circuit of the mold clamping sensor 48 is changed from the high voltage V_{H} to a middle voltage V_{M}. In addition, while it is necessary to detect the mold clamping force with a certain precision, damaging the movable mold 51 and the stationary mold 53 is unlikely and therefore high precision is not required for detection.

Then, the mold clamping apparatus 50 performs mold opening operations. As discussed above, the “mold opening” means that the movable platen 52 is retracted from a state where the parting surface of the movable mold 51 is in contact with the parting surface of the stationary mold 53 so that the movable mold 51 is released from contact with the stationary mold 53.

In this mold opening operation, as well as the mold closing operations, the first mold clamping force is set as the mold clamping force. On the other hand, the voltage being input to the bridge circuit of the mold clamping sensor 48 is changed from the middle voltage V_{M} to the low voltage V_{L}. In this operation, high precision is not required for detection and it is possible to prevent overheating the strain gage and generation of detection error due to high temperature.

Near the completion of the mold opening operation, when the movable mold 51 is in the mold opening limit state, as discussed above, the mold clamping force is not set and the original adjustment of the mold clamping sensor 48 is made. Hence, the high voltage V_{H} is input to the bridge circuit of the mold clamping sensor 48.

Thus, in the bridge circuit of the mold clamping sensor 40 provided at the tie bar 55 of the mold clamping apparatus 50 as the pressure detector configured to detect the mold clamping force, the high voltage V_{H} is applied in the mold opening limit state and before completion of the mold closing operations and start of the mold clamping operations, so that detection with high precision is made. During the mold clamping operations, the middle voltage V_{M} is input. In addition, during the mold closing operations and the mold opening operations, the low voltage V_{L} is input. As a result of this, it is possible prevent overheating the strain gage and generation of detection error due to high temperature.

Next, FIG. 1 and FIG. 4 are referred to.

FIG. 4(a) shows the relationships between the molding process (time t) and a set input voltage (V) to the bridge circuit of the load cell 35 for detecting the pressure of the resin filling the heating cylinder 21 by the injection motor 29 of the injection apparatus 20. FIG. 4(b) shows the relationship between the molding process (time t) and the resin pressure (F) to be set.

After the mold opening operations, the ejector apparatus provided in the movable platen 52 is operated so that the molded article molded by the last cycle is pushed out from the movable mold 51.

During this process, since the injection apparatus is not driven, the low voltage V_{L} is input to the bridge circuit in the load cell 35 for detecting the resin pressure. Accordingly, it is possible prevent overheating the strain gage and generation of detection error due to high temperature.

Next, during the injection process, the screw 23 is advanced so that the resin stored at the front part of the screw 23 is injected from the injection nozzle and thereby the cavity formed in the movable mold 51 and the stationary mold 53 is filled with the molten resin. The resin pressure of the head end part of the screw at this time is detected, as the injection pressure, by the load cell 35 for detecting the resin pressure.

In the injection process, the voltage being input to the bridge circuit of the load cell 35 for detecting the resin pressure is changed to a middle voltage V_{M1} that is higher than the low voltage V_{L}. At the end of the injection process, the advancing motion of the screw is converted from a velocity control to a pressure control (V(velocity)/P(pressure) conversion).

After the V/P conversion, the process goes to the holding pressure process so that the resin is held in the cavity formed between the movable mold 51 and the stationary mold 53.

In this holding pressure process, since the resin pressure is controlled by a feedback control loop, it is necessary to detect the resin pressure with higher precision than that in the injection process. The voltage being input to the bridge circuit of the load cell 35 for detecting the resin pressure is changed to a middle voltage V_{M2} that is higher than the middle voltage V_{M1} in the injection process.

Next, the process goes to the metering process. In the metering process, the screw 23 provided in the heating cylinder 21 is rotated by the metering motor 25. The resin is supplied from the hopper to the back part of the screw 23 in the heating cylinder 21. By the rotation of the screw 23, while the supplied resin is melted, a certain amount the molten resin is supplied to the head end part of the heating cylinder 21. During this process, the screw 23 is retracted while the screw 23 receives pressure (back pressure) of the molten resin filling the head end part of the heating cylinder 21.

In the metering process, the back pressure of the molten resin, unlike the resin pressure generated by a positive (active) advancing of the screw 23 by driving of the driving device in the injection process, is a reaction force at the time when the screw 23 is retracted passively due to the molten resin stored at the front part of the screw 23. Because of this, the back pressure is smaller than the resin pressure during the injection process. In addition, since density of the molten resin may be influenced, it is necessary to detect the resin pressure with precision higher than that in the injection process. Because of this, the voltage being input to the bridge circuit of the load cell 35 for detecting the resin pressure is changed to the high voltage V_{H} that is higher than the middle voltage V_{M2} in the holding pressure process.

When the metering process is completed, after the mold opening process, the ejector apparatus provided to the movable platen 52 is operated so that the molded article in the movable mold 51 is pushed out from the movable mold 51. As discussed above, the resin pressure is not set at this time and no loads are applied. The low voltage V_{L} is applied to the bridge circuit of the load cell 35 for detecting the resin pressure. Hence, it is possible to prevent overheating the strain gage and generation of detection error due to high temperature.

Thus, in the bridge circuit of the load cell 35 for detecting the resin pressure provided as the pressure detector configured to detect the pressure of the resin in the heating cylinder 21 by the injection motor 29 of the injection apparatus 20, the high voltage V_{H} is input and detection with high precision is made in the metering process. The intermediate voltage V_{M} is input in the injection process and the holding pressure process. The low voltage V_{L} is input after the metering process is completed and before the injection process is started. As a result of this, it is possible to prevent overheating the strain gage and generation of detection error due to high temperature.

Next, FIG. 1 and FIG. 5 are referred.

FIG. 5(a) shows the relationships between the molding process (time t) and a set input voltage (V) to the bridge circuit of the load cell 87 for detecting the ejection force as the pressure detector configured to detect the ejection force by the ejector rod 86 of the ejector apparatus. FIG. 5(b) shows the relationship between the molding process (time t) and the resin pressure (F) to be set.

The ejector apparatus performs ejection operations for ejecting the cooled and solidified article from the movable mold 51 and the stationary mold 51 after the movable mold 51 and the stationary mold 51 are opened in parallel with the metering process by the injection apparatus 20. In this example, ejection operations of the molded article by the ejector rod 86 are performed three time so that the set ejection forces haves high values three times during the ejection operations.

Since the ejection force by the ejector rod 86 is detected by the load cell 87 for detecting the ejection force, during the ejection operations, the high voltage V_{H} is input to the bridge circuit of the load cell 87 for detecting the ejection force so that detection with high precision can be made.

On the other hand, when the ejection operations are completed and the molded article is discharged, the movable mold 51 and the stationary mold 53 are closed and the process goes to the mold clamping process and the injection process. After the injection process is completed, the process goes to the mold opening process. After the mold closing process is started and before the mold opening process is completed, namely after the ejection operations are completed and before the ejection operation of next molding cycle is started, the ejection force is not set and no load is applied. The low voltage V_{L} is input to the bridge circuit of the load cell 87 for detecting the ejection force. Accordingly, it is possible to prevent overheating the strain gage and generation of detection error due to high temperature.

Thus, in the bridge circuit of the load cell 87 for detecting the ejection force as the pressure detector configured to detect the ejection force by the ejector rod 86 of the ejector device, the high voltage V_{H} is input and detection with high precision is made during the ejection operations. The low voltage V_{L} is input to the bridge circuit of the load cell 87 after the injection process is completed, and the process goes to the mold opening process, that is, after the mold closing process is started and before the mold opening process is completed, namely after the ejection operations are completed and before the ejection operation of next molding cycle is started. Hence, it is possible prevent overheating the strain gage and generation of detection error due to high temperature.

As discussed above, according to the embodiments of the present invention, the input voltage to the bridge circuit of the pressure detector such as the mold clamping force sensor 48, the load cell 35 for detecting resin pressure, and load cell 87 for detecting the ejector force is variable and the value of the input voltage is changed based on the level of the detection precision to be required.

In a case where the applied loads (pressure) are detected with high precision, the input voltage is high and it is possible to drastically reduce influence of disturbance such as a peripheral device including a motor so that precise output can be achieved by increasing the SN ratio. On the other hand, if high precision is not required for detection, the input voltage is low. Accordingly, it is possible to avoid the situation where the high voltage is always applied so that a situation where the strain gage is heated so as to have a high temperature and detection error is generated is prevented.

Although the invention has been described with respect to specific embodiment for a complete and clear disclosure, the appended claims are not to be thus limited but are to be construed as embodying all modifications and alternative constructions that may occur to one skilled in the art that fairly fall within the basic teachings herein set forth.

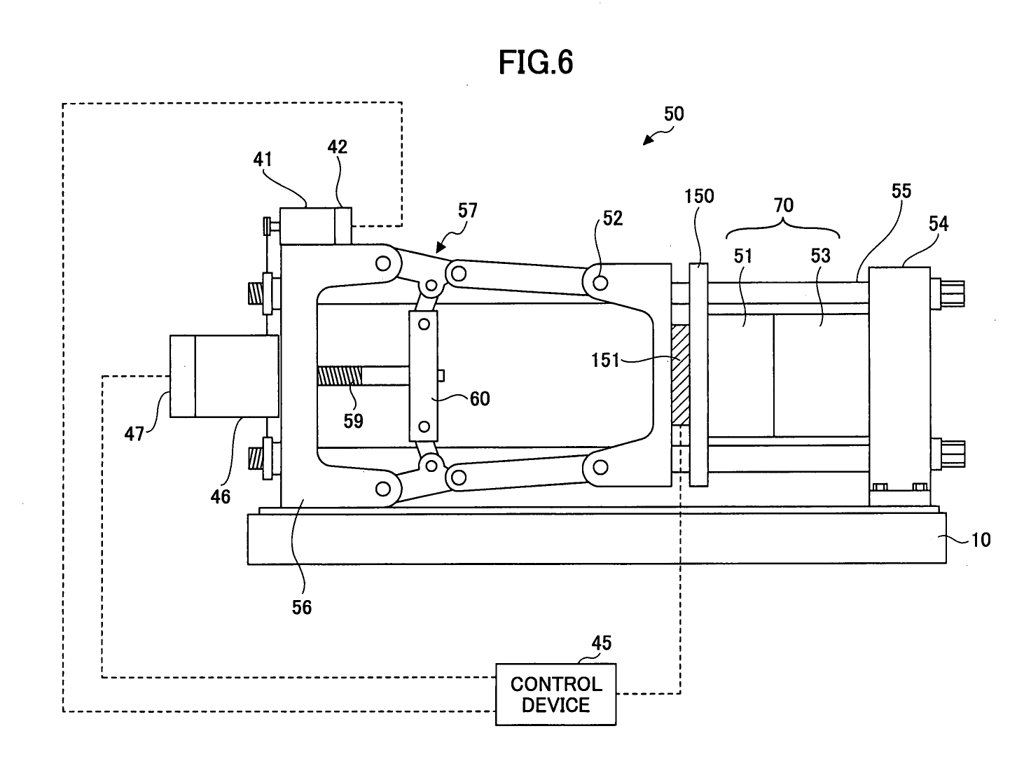

In the above-discussed embodiments, a structure where the mold clamping force of the mold apparatus 70 is detected by the mold clamping force sensor 48 is explained as an example. However, the present invention is not limited to this structure. For example, the present invention can be applied to a structure show in FIG. 6.

Here, FIG. 6 is a schematic view showing another structure of the mold clamping apparatus of the injection molding machine where the present invention is applied. In FIG. 6, parts that are the same as the parts shown in FIG. 1 are given the same reference numerals, and explanation thereof is omitted.

Referring to FIG. 6, the movable mold 51 is attached to a movable mold attaching plate 150. A load cell 151 for detecting a mold clamping force is provided between the movable mold attaching plate 150 and the movable platen 52. The load cell 151 for detecting the mold clamping force, as well as the mold clamping force sensor 48 shown in FIG. 1, is configured to detect a mold clamping force actually applied to the mold apparatus 70. The present invention can be applied to such a load cell 151 for detecting the mold clamping force.

This international patent application is based on Japanese Priority Patent Application No. 2006-252523 filed on Sep. 19, 2006, the entire contents of which are hereby incorporated herein by reference.

### INDUSTRIAL APPLICABILITY

The present invention is applicable to injection molding machines and a control method of the injection molding machines. More specifically, the present invention is applicable to an injection molding machine having a pressure detector such as a load cell and a method for inputting voltage to the pressure detector such as the load cell provided in the injection molding machine.

1. An injection molding machine, comprising:
a pressure detector being a strain detector configured to detect strain when voltage is input to the pressure detector;
wherein a value of the voltage being input to the pressure detector is changed during one molding cycle.

2. The injection molding machine as claimed in claim 1,
wherein the pressure detector includes a variable amplification device, and
a ratio of the voltage being input to the pressure detector and a voltage being output from the pressure detector is calculated by the variable amplification device.

3. The injection molding machine as claimed in claim 1,
wherein the pressure detector is configured to detect a mold clamping force of a mold clamping apparatus, and
the voltage being input to the pressure detector has a highest value in a case where the mold clamping apparatus is in a mold opening limit state or before the mold clamping apparatus performs a mold clamping operation.

4. The injection molding machine as claimed in claim 1,
wherein the pressure detector is configured to detect a mold clamping force of a mold clamping apparatus, and
the voltage being input to the pressure detector has a lowest value during at least a mold opening operation or a mold closing operation.

5. The injection molding machine as claimed in claim 1,
wherein the pressure detector is configured to detect an injection pressure of an injection apparatus, and
the voltage being input to the pressure detector has a highest value during a metering process.

6. The injection molding machine as claimed in claim 1,
wherein the pressure detector is configured to detect an injection pressure of an injection apparatus, and
the voltage being input to the pressure detector has a lowest value after a metering process is completed before an injection process is started.

7. The injection molding machine as claimed in claim 1,
wherein the pressure detector is configured to detect an ejection force of an ejection apparatus, and
the voltage being input to the pressure detector has a highest value during an ejection operation.

8. The injection molding machine as claimed in claim 1,
wherein the pressure detector is configured to detect an ejection force of an ejection apparatus, and
the voltage being input to the pressure detector has a lowest value after an ejection operation is completed before the ejection operation of a next molding cycle is started.

9. A control method of an injection molding machine, the injection molding machine having a pressure detector being a strain detector configured to detect strain when voltage is input to the pressure detector, the control method comprising the steps of
changing a value of the voltage being input to the pressure detector during one molding cycle.

10. The control method of the injection molding machine as claimed in claim 9,
wherein the pressure detector is configured to detect a mold clamping force of a mold clamping apparatus, and
the voltage being input to the pressure detector is changed so as to have a highest value in a case where the mold clamping apparatus is in a mold opening limit state or before the mold clamping apparatus performs a mold clamping operation.

11. The control method of the injection molding machine as claimed in claim 9,
wherein the pressure detector is configured to detect a mold clamping force of a mold clamping apparatus, and
the voltage being input to the pressure detector is changed so as to have a lowest value during a mold opening operation or a mold closing operation.

12. The control method of the injection molding machine as claimed in claim 9,
wherein the pressure detector is configured to detect an injection pressure of an injection apparatus, and
the voltage being input to the pressure detector is changed so as to have a highest value during a metering process.

13. The control method of the injection molding machine as claimed in claim 9,
wherein the pressure detector is configured to detect an injection pressure of an injection apparatus, and
the voltage being input to the pressure detector is changed so as to have a lowest value after a metering process is completed before an injection process is started.

14. The control method of the injection molding machine as claimed in claim 9,
wherein the pressure detector is configured to detect an ejection force of an ejection apparatus, and
the voltage being input to the pressure detector is changed so as to have a highest value during an ejection operation.

15. The control method of the injection molding machine as claimed in claim 9,
wherein the pressure detector is configured to detect an ejection force of an ejection apparatus, and
the voltage being input to the pressure detector is changed so as to have a lowest value after an ejection operation is completed before the ejection operation of a next molding cycle is started.
